(19) United States
(12) Patent Application Publication
(10) Pub. No.: US 2006/0070577 A1
(43) Pub. Date: Apr. 6, 2006

(54) Combined pet cushion cover and tote

(76) Inventor: Carla M. Foley, Dedham, MA (US)

Correspondence Address: CESARI AND MCKENNA, LLP, 88 BLACK FALCON AVENUE, BOSTON, MA, 02210, US

(21) Appl. No.: 10/956,275

(22) Filed: Oct. 1, 2004

(51) Int. Cl. A01K 29/00

(52) U.S. Cl. 119/28.5

(57) ABSTRACT

A combined pet cushion cover and tote includes a defined piece of flexible material having a hem at its perimeter defining a channel. A plurality of openings are present in said material piece the openings being spaced along the hem and opening into the channel. A drawstring extends along the channel, the drawstring having a loops projecting from the channel through the openings to the outside, each loop including two legs and a closed end connecting said legs. A clamp is releaseably clamped to the legs of each loop each clamp being adjustable along the corresponding loop to fix the distance between the closed end of the loop and the opening through which that loop projects.

### BACKGROUND OF THE INVENTION

This invention relates to a pet product. It relates especially to a pet cushion cover which can also be used as a tote for pet supplies.

A pet cushion or pet bed is a soft pillow-like article which is usually placed on the floor and on which a dog, cat or other pet may comfortably rest or nap. Usually, such cushions have an outer cover which is filled with a soft material such as plastic foam, feathers or other such stuffings. In some cushions, the cover is removable. In other words, it is made as a pocket that may contain an interior self-contained cushion pillow and with an entrance which may be closed by a slide fastener, hook and loop fastener, snap buttons or the like. However, such covers are disadvantaged in that they only accommodate an interior cushion of a selected size. Also, some conventional covers of this general type are not waterproof. Resultantly, they do not adequately protect the interior cushion.

Invariably also, the covers for conventional pet cushions are dedicated to that use; they have no other useful purpose.

### SUMMARY OF THE INVENTION

Accordingly, it is an object of the present invention to provide a pet cushion cover which can also be used as a tote to carry around pet supplies and other articles.

Another object of the invention is to provide a pet cushion cover which can be adjusted to fit interior pillows or cushions of various sizes.

A further object of the invention is to provide such a cover which protects the underlying cushion.

A further object of the invention is to provide a pet cushion cover which can easily be installed on and removed from the underlying cushion.

Yet another object of the invention is to provide a cover of this type which is relatively easy and inexpensive to make.

Other objects will, in part, be obvious and will, in part, appear hereinafter.

The invention accordingly comprises the features of construction, combination of elements and arrangement of parts which will be exemplified in the following detailed description, and the scope of the invention will be indicated in the claims.

Briefly, my pet cushion cover comprises a defined sheet of flexible material, which may be lined and which is hemmed at its periphery to define a channel for containing a drawcord. Holes are present in the material at spaced apart locations along the hem. These holes open into the channel and the loops of the drawcord project out of the channel through these holes. A clamp is present at the base of each loop which is larger than the hole through which that loop projects so that the loop is prevented from being drawn back into the channel. Also, the clips permit adjustment of the sizes of the loops that project through the holes when the cover has been fitted to a cushion as will be described. Preferably also, hooks are secured to the closed ends of the loops. These hooks may be hooked together when the cover is being used as a tote in a manner to be described later.

In use, the cover is placed on the top of an interior cushion or pillow so that an edge margin of the cover extends beyond the edge of that cushion or pillow. Then, the drawstring loops are drawn from their respective openings thereby reducing the length of the drawstring remaining in the channel. Resultantly, the hemmed edge of the cover is pulled inward under the edge of the cushion and gathered at the underside of the cushion. Once the cover is pulled taut around the cushion, the clamps are slid along the loops to positions adjacent to the loop openings to fix the amount of drawstring remaining in the channel. The clips secured to the loops may then be clipped together at the underside of the covered cushion so secure the lengths of drawstring extending from the cover.

In order to use the cover as a tote, the cover is removed from its interior cushion and the drawstring loops are pulled out of their respective openings so that they function as purse strings which gather the hemmed edge of the cover to form a pouch or tote. The size of the opening into the tote may be adjusted by appropriately positioning the clamps along the drawstring loops. Also, the closed ends of the loops may be secured together by means of the clips.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective view from above of a pet cushion having a cover incorporating the invention;

FIG. 2 is a bottom-plan view thereof;

FIG. 3 is a top-plan view with parts broken away showing the cover in FIG. 1 in greater detail, and

FIG. 4 is a side-elevational view of the cover being used as a tote.

### DESCRIPTION OF THE PREFERRED EMBODIMENT

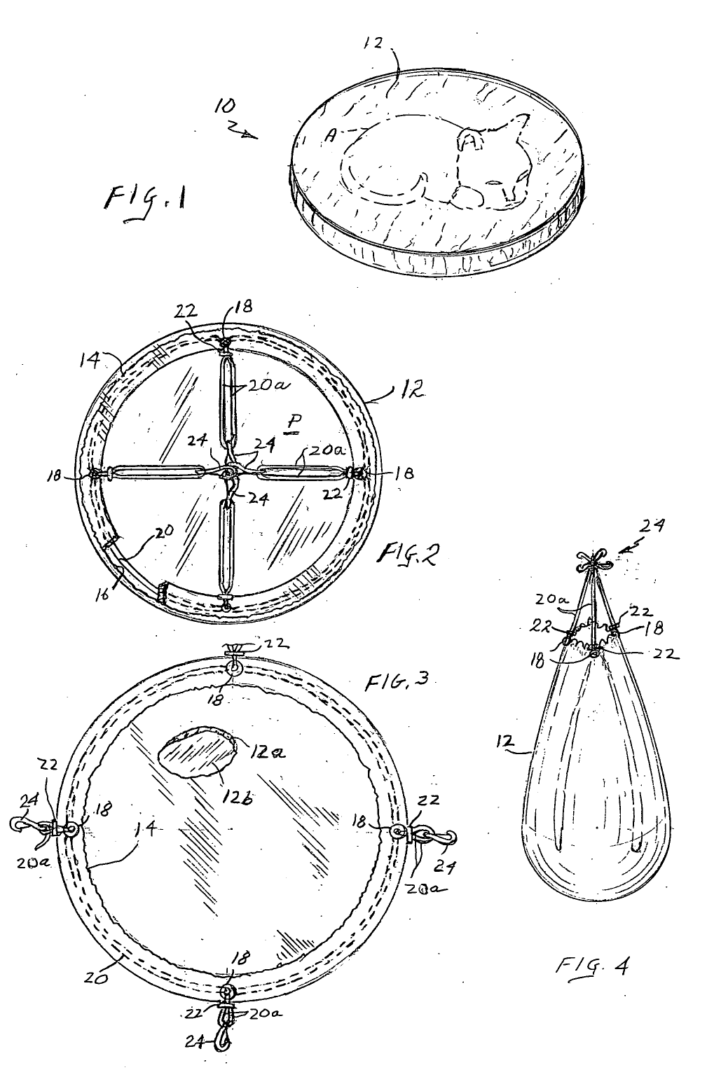

Refer now to FIGS. 1 and 2 which show a pet cushion indicated generally at 10 comprising a standard inner cushion or pillow P and an outer cover 12 which protectively encloses the pillow P. Cushion 10 is shaped and sized to comfortably support an animal A such as a dog or cat. The pillow P may be a bed pillow or an old sofa cushion or a conventional pet cushion.

Refer now to FIG. 3 which shows the cover 12 in greater detail. It comprises an outer layer 12a of a decorative material such as a woven fabric and an inner or under layer 12b of a waterproof or water-resistant material such as plastic sheeting. The two layers are superimposed and folded at their edge margins and hemmed at 14 to form a channel 16 which extends all around the perimeter of the cover. Preferably, the shape of the hemmed cover corresponds more or less to the shape of the pillow P in FIG. 2 and the hemmed cover should be somewhat larger than the pillow P so that an edge margin of the cover overhangs the pillow.

A plurality of openings 18 are provided in cover layer 12a at spaced-apart locations along the perimeter of the cover. These openings all open into channel 16 and they are preferably fitted with eyelets 18a to reinforce the edges of the openings. The illustrated cover has 12 four such openings but there could, of course be three or more than four.

As seen in FIG. 3, an endless drawstring 20 extends along channel 16 with drawstring loops 20a projecting out through the openings 18. This drawstring may be inextensible or, more preferably, somewhat elastic. When the cover 12 is laid out flat as in FIG. 3, the loops 20a are relatively small. These loops may be made larger by pulling them away from openings 18 which, of course, reduces the length of drawstring 20 remaining in channel 16 resulting in a gathering of the hemmed edge of the cover.

A conventional clamp 22 is provided at each drawstring loop 20a. Each clamp has two holes through which pass the two legs of the associated loop 20a. The clamp includes a spring-loaded button 22a which, in its retracted position at least partially occludes those holes. When the button is pushed, the clamp is free to slide along the legs of the associated loop. When the button is released, its button clamps the loop legs and thus fixes the position of the clamp along the loop. The clamps 22 are larger than the openings 18 so that they prevent the clamps from being pulled back into channel 16 through openings 18.

The clamps may also be adjusted to fix the size of the loop 20a projecting through the corresponding opening 18. In other words, when a given loop 20a is enlarged or lengthened by pulling it away from the corresponding opening 18, that loop length may be fixed by sliding the associated clamp 22 along the loop legs until the clamp is positioned adjacent to the corresponding opening 18.

Preferably also, each loop carries a conventional spring clip 24 for reasons that will become apparent.

To use, the cover shown in FIG. 3 is placed on pillow or cushion P so that an edge margin of the cover overhangs the pillow. Then, the drawstring loops 20a are pulled away from their respective openings 18 so that the loops are enlarged. This shortens the length of drawstring 20 remaining in channel 16 resulting in a gathering of the hemmed edge of the cover under pillow P as shown in FIG. 2. Once the cover 12 has been pulled somewhat taut around the pillow, the lengths of the drawstring loops 20a may be fixed by sliding clamps 22 along the drawstring loops to position them adjacent to the respective openings 18. The clips 24 may then be clipped together as shown in FIG. 2 to hold loops 20a in place at the underside of cushion 10.

It will be appreciated that by properly pulling on loops 20a, the cover 12 may be drawn taut around various sized pillows or cushions P so long as the pillow or cushion is smaller than that of the cover 12. When installed on a pillow P, cover 12 protectively encloses the pillow so that it is no longer necessary to clean or launder the pillow; it is only necessary to launder cover 12 from time to time.

Returning to FIG. 4, cover 12 may be removed from pillow P and used as a tote for carrying pet supplies or other articles. For this, the drawstring loops 20a are pulled away from their respective openings 18 sufficiently to gather the hemmed edge of cover 12 so that the cover forms a pouch. The size of the opening into the top of the pouch depends on the lengths of the drawstring loops 20a projecting from openings 18. When elongated to a maximum degree, the loops form a purse string which completely closes the opening into the pouch or tote. The free ends of the drawstring loops 20a may be secured together using clips 24 as shown in FIG. 4.

The combined pet cushion and tote described above can be made with standard materials using simple cutting and sewing operations. Therefore, it should be relatively inexpensive to manufacture.

It will thus be seen that the objects set forth above among those made apparent from the preceding description are efficiently attained. Also, since certain changes may be made in the above construction without the departing from the scope of the invention, it is intended that all matter contained in the above description or shown in the accompanying drawing shall be interpreted as illustrative and not in a liming sense.

It is also to be understood that the following claims are intended to cover all of the generic and specific features of the invention described herein.

What is claimed is:

1. A combined pet cushion cover and tote comprising:
a defined piece of flexible material having a hem at its perimeter defining a channel, said material piece being similar in shape to and larger than a cushion to be covered;
a plurality of openings in said material piece, said openings being spaced along said hem and opening into said channel;
a drawstring extending along said channel, said drawstring having loops projecting from said channel through said openings to the outside, each loop having two legs and a closed end connecting said legs, and
a clamp releaseably clamped to the legs of each loop each clamp being adjustable along the corresponding loop to fix the distance between the closed end of the loop and the opening through which that loop projects.

2. The combined cover and tote defined in claim 1 and further including a flexible, water-resistant or waterproof liner lining said material piece, said liner being more or less congruent to said material piece and secured to said material piece at said hem.

3. The combined cover and tote defined in claim 1 and further including a clip secured to each loop, each clip being adapted to be clipped to the clips on the other loops to secure together the closed ends of the loops.

4. The combined cover and tote defined in claim 1 where in the drawcord is elastic.

5. The combined cover and tote defined in claim 1 and further including a rigid eyelet fixed to the piece of flexible material at each hole.
